(19) United States
(12) Patent Application Publication
(10) Pub. No.: US 2018/0187564 A1
(43) Pub. Date: Jul. 5, 2018

(54) STRUCTURE BRAZE OF HARD-TO-WELD SUPERALLOY COMPONENTS USING DIFFUSION ALLOY INSERT

(71) Applicant: GENERAL ELECTRIC COMPANY, Schenectady, NY (US)

(72) Inventors: Yan CUI, Greer, SC (US); Srikanth Chandrudu KOTTILINGAM, Simpsonville, SC (US); Brian Lee TOLLISON, Honea Path, SC (US); Dechao LIN, Greer, SC (US); Cem Murat EMINOGLU, Simpsonville, SC (US)

(21) Appl. No.: 15/397,840

(22) Filed: Jan. 4, 2017

(51) Int. Cl. F01D 9/04; B23K 1/00; B23K 1/20; B23P 6/00; G01B 11/03; F01D 5/30

(52) U.S. Cl. CPC F01D 9/042; B23K 1/0018; B23K 1/20; B23K 2201/001; G01B 11/03; F01D 5/3061; B23P 6/002

(57) ABSTRACT

A method for treating a component and a treated component are provided. The method includes the steps of machining a tapered slot in the component. The tapered slot is measured to determine dimensions. An insert is formed to have a corresponding geometry to the tapered slot with a braze gap between an outer surface of the insert and an inner surface of the tapered slot. A layer of a braze material is deposited on the outer surface of the insert, where a thickness of the layer corresponds to the braze gap. The layer of the braze material on the outer surface of the insert is sintered to fabricate a diffusion layer. The insert is positioned into the tapered slot. The diffusion layer is brazed to join the insert to the taper slot. The treated component includes a surface having a tapered slot, an insert, and a braze joint.

### FIELD OF THE INVENTION

The present invention is directed to a repair of hard-to-weld superalloy components, and more specifically to a structural braze repair of hard-to-weld superalloy components using diffusion alloy insert.

### BACKGROUND OF THE INVENTION

Gas turbine machines typically use high strength and oxidation resistant hard-to-weld (HTW) alloys to fabricate hot gas path components, such as airfoils, buckets, blades, nozzles, vanes, shrouds, rotating turbine components, wheels, seals, combustor liners, 3D-manufactured components and transition ducts. Hard-to-weld (HTW) alloys typically show desirable mechanical properties for turbine operating temperatures and conditions.

However, during operation, components formed from hard-to-weld (HTW) alloys experience severe working environment, and material degradation will occur due to fatigue, creep, corrosion or oxidization.

Brazing has been largely used to rejuvenate service-run parts. Brazing shows a great mechanical strength only if the brazing gap size is very narrow in the brazing joint. Otherwise, brazing does not provide service-run parts with a sufficiently high mechanical strength for operation. However, in the production, it is hard to control the gap size to the desired dimension.

Yet, no engineering practice has been reported to disclose a method to provide the service-run parts with a great mechanical strength with a controlled narrow brazing gap size.

### BRIEF SUMMARY OF THE INVENTION

In an exemplary embodiment, a method for treating a component is provided. The method for treating a component includes the steps of machining a tapered slot in the component to remove a defect-containing portion of the component. The tapered slot is measured to determine the dimension. An insert is formed to have a corresponding geometry to the tapered slot with a braze gap between an outer surface of the insert and an inner surface of the tapered slot. A layer of a braze material is deposited on the outer surface of the insert, where a thickness of the layer corresponds to the braze gap. The layer of the braze material is sintered on the outer surface of the insert to fabricate a diffusion layer. The insert is positioned into the tapered slot. The component is brazed to join the insert to the component.

In another exemplary embodiment, a method for treating a superalloy turbine component is provided. The method for treating a superalloy turbine component includes the step of machining a tapered slot in the superalloy turbine component to remove a defect-containing portion of the superalloy turbine component. The tapered slot is measured to determine the tapered slot dimensions. An insert is formed to have a corresponding geometry to the tapered slot with a braze gap ranging from about 0.0005 to about 0.01 inches between an outer surface of the insert and an inner surface of the tapered slot. A layer of a braze material is deposited on the outer surface of the insert. The layer of the braze material is sintered on the outer surface of the insert to fabricate a diffusion layer at a temperature between about 1800 and about 2300° F. The insert is positioned into the tapered slot and the superalloy turbine component is brazed to join the insert to the superalloy turbine component at a temperature between about 1800 and about 2350° F.

In another exemplary embodiment, a treated superalloy turbine component is provided. The treated superalloy turbine component includes a surface having a tapered slot. An insert is positioned within the tapered slot. A braze gap ranging from 0.0005 to 0.01 inches is present between an outer surface of the insert and an inner surface of the tapered slot. The component also includes a braze joint. The braze joint includes a braze material positioned in the braze gap. The braze material is a sintered material on the outer surface of the insert. The superalloy turbine component includes a diffusion layer between the insert and the superalloy turbine component.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a flow chart illustrating one embodiment of a method of treating a component.

FIG. 2 is a perspective view of a component including a treatment region, according to an embodiment of the present disclosure.

FIG. 3 shows a schematic view of a method according to the present disclosure.

FIG. 4 is a cross-section view taken along line 4-4 in FIG. 3.

FIG. 5 is a cross-section view taken along line 5-5 in FIG. 3.

FIG. 6 is a cross-section view taken along line 6-6 in FIG. 3.

Wherever possible, the same reference numbers will be used throughout the drawings to represent the same parts.

### DETAILED DESCRIPTION OF THE INVENTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

All numbers expressing quantities of ingredients and/or reaction conditions are to be understood as being modified in all instances by the term “about”, unless otherwise indicated.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun terms denotes a particular specified feature or particular specified features and may have a singular or plural connotation depending upon the context in which it is used. The adjective “any” means one, some, or all indiscriminately of whatever quantity.

All percentages and ratios are calculated by weight unless otherwise indicated. All percentages are calculated based on the total weight of a composition unless otherwise indicated. All component or composition levels are in reference to the active level of that component or composition, and are exclusive of impurities, for example, residual solvents or by-products, which may be present in commercially available sources.

The term “tapered”, as used herein, and variations of this term, refer to any shape diminishing, reducing, or causing to diminish or reduce in thickness toward one end. In some embodiments, the cross section of “tapered” shape may include, but not be limited to, a V-shape and a U-shape.

The term “non-tapered”, as used herein, and variations of this term, refer to any shape being constant in thickness toward one end. In some embodiments, the cross-section of “non-tapered” shape may include, but not be limited to, a [symbol] -shape.

The term “machining”, as used herein, and variations of this term, refer to any process that is capable of controllably removing material from a component. Examples of machining include, but are not limited to post-fabrication drilling, electrical discharge machining (EDM), laser drilling, mechanical drilling, vibrational drilling, milling, computer numerical control milling, water jet cutting, abrasive jet cutting, punching, formation by an additive manufacturing technique, 3D printing, or combinations thereof.

The present invention may comprise an embodiment including a method for treating a component with a controlled narrow brazing gap size to provide the component with a great mechanical strength. The component herein illustrated may comprise a metal or an alloy. The alloy may comprise a superalloy. The term “superalloy” is used herein as it is commonly used in the art; i.e., a highly corrosion and oxidation resistant alloy that exhibits excellent mechanical strength and resistance to creep at high temperatures.

In some embodiments, the component may include, but not be limited to, a single crystal (SX) material, a directionally solidified (DS) material, an equiaxed crystal (EX) material, and combinations thereof.

In some embodiments, the superalloy may include nickel-based superalloy, cobalt-based superalloy, iron-based superalloy, titanium-based superalloy, or combinations thereof. The superalloy may include, but not be limited to, a material selected from the group consisting of Hastelloy, Inconel alloys, Waspaloy, Rene alloys, such as GTD111, GTD222, GTD444, GTD262, Mar M247, IN100, IN 738, René 80, IN 939, René N2, René N4, René N5, René N6, René 65, René 77 (Udimet 700), René 80, René 88DT, René 104, René 108, René 125, Rene 142, René 195, René N500, René N515, IN 706, Nimonic 263, CM247, MarM247, CMSX-4, MGA1400, MGA2400, INCONEL 700, INCONEL 738, INCONEL 792, DS Siemet, CMSX10, PWA1480, PWA1483, PWA1484, TMS-75, TMS-82, Mar-M-200, UDIMET 500, ASTROLOY, and combinations thereof.

As used herein, “ASTROLOY” refers to an alloy including a composition, by weight, of about 15% chromium, about 17% cobalt, about 5.3% molybdenum, about 4% aluminum, about 3.5% titanium, and a balance of nickel.

As used herein, “DS Siemet” refers to an alloy including a composition, by weight, of about 9% cobalt, about 12.1% chromium, about 3.6% aluminum, about 4% titanium, about 5.2% tantalum, about 3.7% tungsten, about 1.8% molybdenum, and a balance of nickel.

As used herein, “GTD111” refers to an alloy including a composition, by weight, of about 14% chromium, about 9.5% cobalt, about 3.8% tungsten, about 4.9% titanium, about 3% aluminum, about 0.1% iron, about 2.8% tantalum, about 1.6% molybdenum, about 0.1% carbon, and a balance of nickel.

As used herein, “GTD262” refers to an alloy including a composition, by weight, of about 22.5% chromium, about 19% cobalt, about 2% tungsten, about 1.35% niobium, about 2.3% titanium, about 1.7% aluminum, about 0.1% carbon, and a balance of nickel.

As used herein, “GTD444” refers to an alloy including a composition, by weight, of about 7.5% cobalt, about 0.2% iron, about 9.75% chromium, about 4.2% aluminum, about 3.5% titanium, about 4.8% tantalum, about 6% tungsten, about 1.5% molybdenum, about 0.5% niobium, about 0.2% silicon, about 0.15% hafnium, and a balance of nickel.

As used herein, “MGA1400” refers to an alloy including a composition, by weight, of about 10% cobalt, about 14% chromium, about 4% aluminum, about 2.7% titanium, about 4.7% tantalum, about 4.3% tungsten, about 1.5% molybdenum, about 0.1% carbon, and a balance of nickel.

As used herein, “MGA2400” refers to an alloy including a composition, by weight, of about 19% cobalt, about 19% chromium, about 1.9% aluminum, about 3.7% titanium, about 1.4% tantalum, about 6% tungsten, about 1% niobium, about 0.1% carbon, and a balance of nickel.

As used herein, “PMA 1480” refers to an alloy including a composition, by weight, of about 10% chromium, about 5% cobalt, about 5% aluminum, about 1.5% titanium, about 12% tantalum, about 4% tungsten, and a balance of nickel.

As used herein, “PWA1483” refers to an alloy including a composition, by weight, of about 9% cobalt, about 12.2% chromium, about 3.6% aluminum, about 4.1% titanium, about 5% tantalum, about 3.8% tungsten, about 1.9% molybdenum, and a balance of nickel.

As used herein, “PMA 1484” refers to an alloy including a composition, by weight, of about 5% chromium, about 10% cobalt, about 2% molybdenum, about 5.6% aluminum, about 9% tantalum, about 6% tungsten, and a balance of nickel.

As used herein, “René N2” refers to an alloy including a composition, by weight, of about 7.5% cobalt, about 13% chromium, about 6.6% aluminum, about 5% tantalum, about 3.8% tungsten, about 1.6% rhenium, about 0.15% hafnium, and a balance of nickel.

As used herein, “René N4” refers to an alloy including a composition, by weight, of about 9.75% chromium, about 7.5% cobalt, about 4.2% aluminum, about 3.5% titanium, about 1.5% molybdenum, about 6.0% tungsten, about 4.8% tantalum, about 0.5% niobium, about 0.15% hafnium, and a balance of nickel.

As used herein, “René N5” refers to an alloy including a composition, by weight, of about 7.5% cobalt, about 7.0% chromium, about 6.5% tantalum, about 6.2% aluminum, about 5.0% tungsten, about 3.0% rhenium, about 1.5% molybdenum, about 0.15% hafnium, and a balance of nickel.

As used herein, “René N6” refers to an alloy including a composition, by weight, of about 12.5% cobalt, about 4.2% chromium, about 7.2% tantalum, about 5.75% aluminum, about 6% tungsten, about 5.4% rhenium, about 1.4% molybdenum, about 0.15% hafnium, and a balance of nickel.

As used herein, “René 65” refers to an alloy including a composition, by weight, of about 13% cobalt, up to about 1.2% iron, about 16% chromium, about 2.1% aluminum, about 3.75% titanium, about 4% tungsten, about 4% molybdenum, about 0.7% niobium, up to about 0.15% manganese, and a balance of nickel.

As used herein, “René 77 (Udimet 700)” refers to an alloy including a composition, by weight, of about 15% chromium, about 17% cobalt, about 5.3% molybdenum, about 3.35% titanium, about 4.2% aluminum, and a balance of nickel.

As used herein, “René 80” refers to an alloy including a composition, by weight, of about 14% chromium, about 9.5% cobalt, about 4% molybdenum, about 3% aluminum, about 5% titanium, about 4% tungsten, about 0.17% carbon, and a balance of nickel.

As used herein, “René 88DT” refers to an alloy including a composition, by weight, of about 16% chromium, about 13% cobalt, about 4% molybdenum, about 0.7% niobium, about 2.1% aluminum, about 3.7% titanium, about 4% tungsten, about 0.1% rhenium, a maximum of about 4.3% rhenium and tungsten, and a balance of nickel.

As used herein, “René 104” refers to an alloy including a composition, by weight, of about 13.1% chromium, about 18.2% cobalt, about 3.8% molybdenum, about 1.9% tungsten, about 1.4% niobium, about 3.5% aluminum, about 3.5% titanium, about 2.7% tantalum, and a balance of nickel.

As used herein, “René 108” refers to an alloy including a composition, by weight, of about 8.4% chromium, about 9.5% cobalt, about 5.5% aluminum, about 0.7% titanium, about 9.5% tungsten, about 0.5% molybdenum, about 3% tantalum, about 1.5% hafnium, and a balance of nickel.

As used herein, “René 125” refers to an alloy including a composition, by weight, of about 8.5% chromium, about 10% cobalt, about 4.8% aluminum, up to about 2.5% titanium, about 8% tungsten, up to about 2% molybdenum, about 3.8% tantalum, about 1.4% hafnium, about 0.11% carbon, and a balance of nickel.

As used herein, “René 142” refers to an alloy including a composition, by weight, of about 6.8% chromium, about 12% cobalt, about 6.1% aluminum, about 4.9% tungsten, about 1.5% molybdenum, about 2.8% rhenium, about 6.4% tantalum, about 1.5% hafnium, and a balance of nickel.

As used herein, “René 195” refers to an alloy including a composition, by weight, of about 7.6% chromium, about 3.1% cobalt, about 7.8% aluminum, about 5.5% tantalum, about 0.1% molybdenum, about 3.9% tungsten, about 1.7% rhenium, about 0.15% hafnium, and a balance of nickel.

As used herein, “René N500” refers to an alloy including a composition, by weight, of about 7.5% cobalt, about 0.2% iron, about 6% chromium, about 6.25% aluminum, about 6.5% tantalum, about 6.25% tungsten, about 1.5% molybdenum, about 0.15% hafnium, and a balance of nickel.

As used herein, “René N515” refers to an alloy including a composition, by weight, of about 7.5% cobalt, about 0.2% iron, about 6% chromium, about 6.25% aluminum, about 6.5% tantalum, about 6.25% tungsten, about 2% molybdenum, about 0.1% niobium, about 1.5% rhenium, about 0.6% hafnium, and a balance of nickel.

As used herein, “MarM247” and “CM247” refer to an alloy including a composition, by weight, of about 5.5% aluminum, about 0.15% carbon, about 8.25% chromium, about 10% cobalt, about 10% tungsten, about 0.7% molybdenum, about 0.5% iron, about 1% titanium, about 3% tantalum, about 1.5% hafnium, and a balance of nickel.

As used herein, “IN100” refers to an alloy including a composition, by weight, of about 10% chromium, about 15% cobalt, about 3% molybdenum, about 4.7% titanium, about 5.5% aluminum, about 0.18% carbon, and a balance of nickel.

As used herein, “INCONEL 700” refers to an alloy including a composition, by weight, of up to about 0.12% carbon, about 15% chromium, about 28.5% cobalt, about 3.75% molybdenum, about 2.2% titanium, about 3% aluminum, about 0.7% iron, up to about 0.3% silicon, up to about 0.1% manganese, and a balance of nickel.

As used herein, “INCONEL 738” refers to an alloy including a composition, by weight, of about 0.17% carbon, about 16% chromium, about 8.5% cobalt, about 1.75% molybdenum, about 2.6% tungsten, about 3.4% titanium, about 3.4% aluminum, about 0.1% zirconium, about 2% niobium, and a balance of nickel.

As used herein, “INCONEL 792” refers to an alloy including a composition, by weight, of about 12.4% chromium, about 9% cobalt, about 1.9% molybdenum, about 3.8% tungsten, about 3.9% tantalum, about 3.1% aluminum, about 4.5% titanium, about 0.12% carbon, about 0.1% zirconium, and a balance of nickel.

As used herein, “UDIMET 500” refers to an alloy including a composition, by weight, of about 18.5% chromium, about 18.5% cobalt, about 4% molybdenum, about 3% titanium, about 3% aluminum, and a balance of nickel.

As used herein, “Mar-M-200” refers to an alloy including a composition, by weight, of about 9% chromium, about 10% cobalt, about 12.5% tungsten, about 1% niobium, about 5% aluminum, about 2% titanium, about 10.14% carbon, about 1.8% hafnium, and a balance of nickel.

As used herein, “TMS-75” refers to an alloy including a composition, by weight, of about 3% chromium, about 12% cobalt, about 2% molybdenum, about 6% tungsten, about 6% aluminum, about 6% tantalum, about 5% rhenium, about 0.1% hafnium, and a balance of nickel.

As used herein, “TMS-82” refers to an alloy including a composition, by weight, of about 4.9% chromium, about 7.8% cobalt, about 1.9% molybdenum, about 2.4% rhenium, about 8.7% tungsten, about 5.3% aluminum, about 0.5% titanium, about 6% tantalum, about 0.1% hafnium, and a balance of nickel.

As used herein, “CMSX-4” refers to an alloy including a composition, by weight, of about 6.4% chromium, about 9.6% cobalt, about 0.6% molybdenum, about 6.4% tungsten, about 5.6% aluminum, about 1.0% titanium, about 6.5% tantalum, about 3% rhenium, about 0.1% hafnium, and a balance of nickel.

As used herein, “CMSX-10” refers to an alloy including a composition, by weight, of about 2% chromium, about 3% cobalt, about 0.4% molybdenum, about 5% tungsten, about 5.7% aluminum, about 0.2% titanium, about 8% tantalum, about 6% rhenium, and a balance of nickel.

Any of the alloy compositions described herein may include incidental impurities.

One embodiment according to the present disclosure includes a method to fabricate a diffusion alloy insert utilized for brazing structural joints with a controlled narrow gap size. The method according to the present disclosure may effectively conduct structural repair of hard-to-weld superalloy. This method may be also utilized for any geometry of insert, and minimize the amount of damaged and/or cracked casting base metal to be removed.

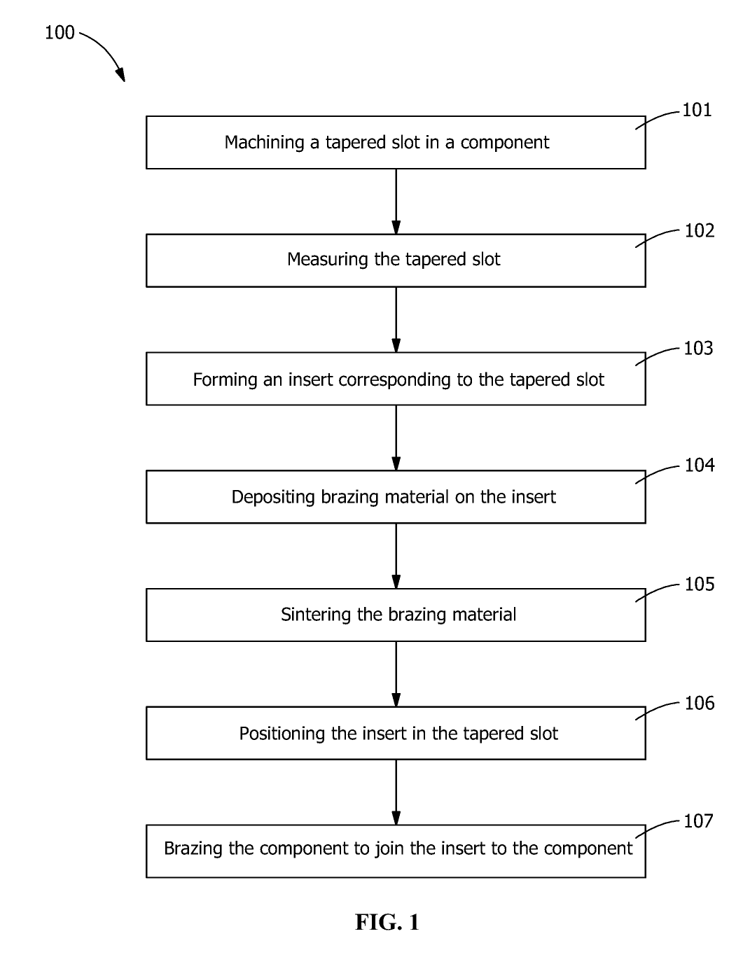

With reference to FIG. 1, a flow chart illustrating a method for treating a component is provided. The method for treating a component includes a step 101 of machining a tapered slot in the component to remove a defect-containing portion of the component. In a step 102, the tapered slot is measured to determine the tapered slot dimension. In a step 103, an insert is formed to have a corresponding geometry to the tapered slot with a braze gap between an outer surface of the insert and an inner surface of the tapered slot. In a step 104, a layer of a braze material is deposited on the outer surface of the insert, where a thickness of the layer corresponds to the braze gap. In a step 105, the layer of the braze material is sintered on the outer surface of the insert to fabricate a diffusion layer. In a step 106, the insert is positioned into the tapered slot. In a step 107, the component is brazed to join the insert to the taper slot of the component.

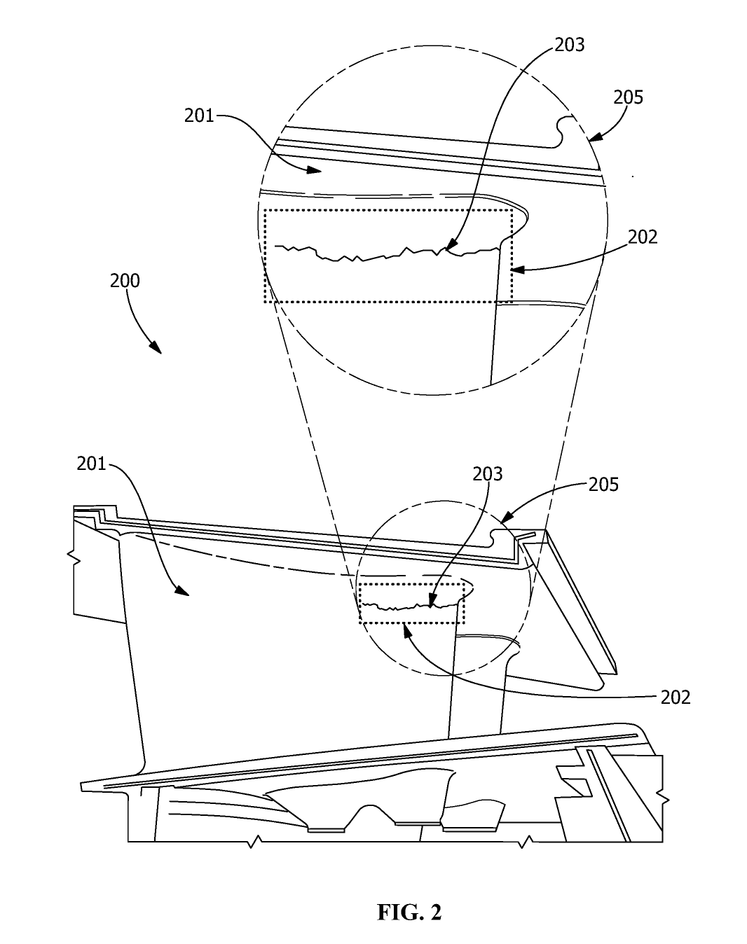

With reference to FIG. 2, a component 201 of a treatment system 200 includes a treatment region 202. The component 201 may be fabricated from any suitable metal or alloy. For example, suitable metals for use as component 201 include but are not limited to superalloys. In particular, component 201 may include nickel cobalt iron-based or titanium based superalloys. The metal alloys may comprise superalloys. The treatment region 202 includes a damaged and/or cracked portion 203. Enlarged portion 205 shows a magnified view of treatment region 202. In some embodiments, the damaged and/or cracked portion 203 may include, but not be limited to, a leading edge, or trailing edge cracks.

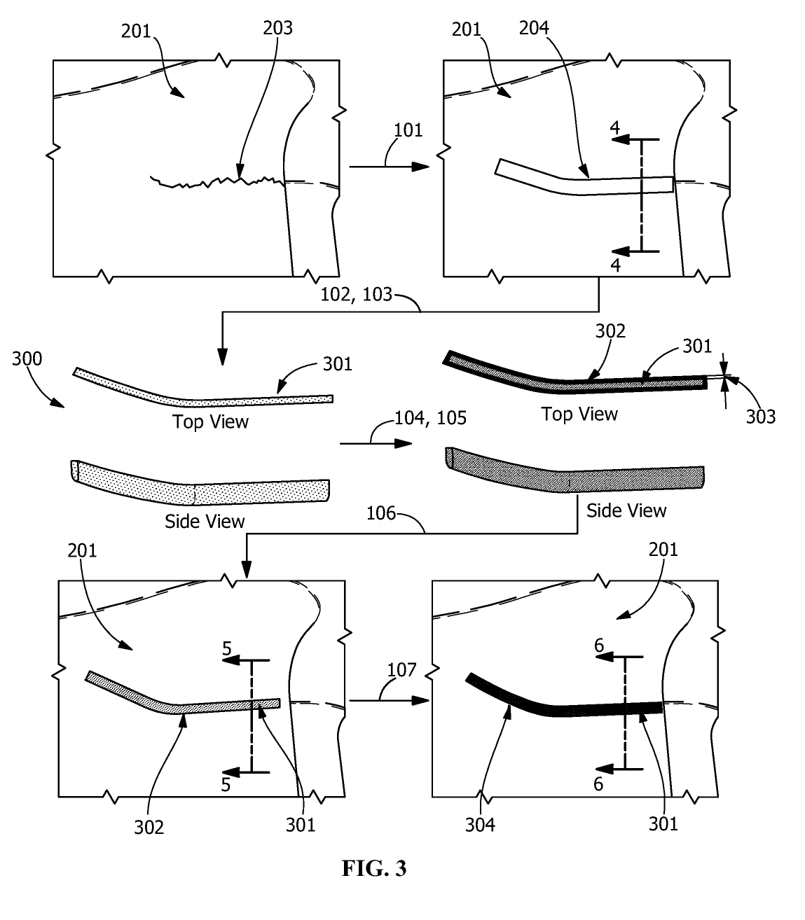

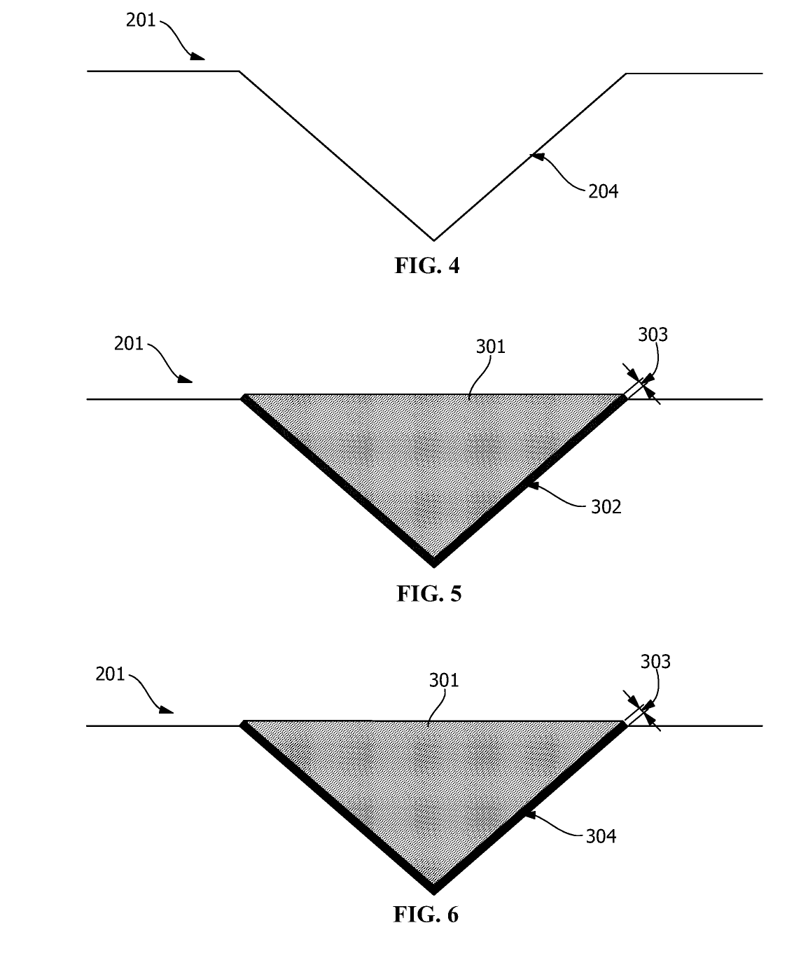

With reference to FIGS. 1 and 3, the method for treating a component 201 includes machining a tapered slot 204 in the component 201 to remove a defect-containing portion of the component 201 (step 101). In some embodiments, step 101 includes a step of machining a non-tapered slot in the component to remove a portion of the component 201. For example, the machining may include post-fabrication drilling, electrical discharge machining (EDM), laser drilling, mechanical drilling, vibrational drilling, milling, computer numerical control milling, water jet cutting, abrasive jet cutting, punching, formation by an additive manufacturing technique, 3D printing, or combinations thereof.

The method further includes measuring tapered slot 204 to determine the tapered slot dimensions (step 102). In certain embodiments, the measuring may further include measuring techniques, such as, but not be limited to, utilizing a white light 3D measurement system, a blue light 3D measurement system, a laser based measuring system, or combinations thereof. The method further includes forming an insert 301 of an insert system 300 to have a corresponding geometry to the tapered slot 204 (step 103). Insert 301 is formed with a geometry that provides a braze gap 303 between an outer surface of the insert 301 and an inner surface of the tapered slot 204, when insert 301 is inserted in tapered slot 204. In one embodiment, the tapered slot dimensions may be determined, for example, by a blue light 3D measurement system.

The forming 103 may include, but not be limited to post-fabrication drilling, electrical discharge machining (EDM), laser drilling, mechanical drilling, vibrational drilling, milling, computer numerical control milling, water jet cutting, abrasive jet cutting, punching, formation by an additive manufacturing technique, 3D printing, or combinations thereof. In one embodiment, the forming includes machining a material to the designed geometry.

The braze gap 303 may be formed between the insert 301 and the inner surface of tapered slot 204 sufficiently small to provide a tensile strength greater than about 500 MPa at room temperature. Thus, in various embodiments, the braze gap may be sufficiently small to provide a tensile strength greater than 600 MPa, greater than 700 MPa, and greater than 800 MPa, greater than 900 MPa, and greater than 1000 MPa at room temperature. In one embodiment, the braze gap may be between about 0.0005 inches and 0.01 inches. Thus, in various embodiments, the braze gap may be from about 0.0005 to about 0.010 inches, from about 0.0010 to about 0.0095 inches, from about 0.0015 to about 0.0090 inches, from about 0.0020 to about 0.0085 inches, from about 0.0025 to about 0.0080 inches, from about 0.0030 to about 0.0075 inches, from about 0.0035 to about 0.0065 inches, from about 0.0040 to about 0.0060 inches, or from about 0.0045 to about 0.0055 inches, including increments and intervals therein.

The insert 301 may include, but not be limited to, a single crystal (SX) material, a directionally solidified (DS) material, an equiaxed crystal (EX) material, and combinations thereof. In one embodiment, insert 301 includes a material that is the same as a material of component 201. In another embodiment, insert 301 includes a material that is dissimilar from a material of component 201.

Also with to FIG. 3, the method includes depositing a layer of braze material on the outer surface of the insert (step 104). In one embodiment, the thickness of the layer may correspond to the braze gap 303 between the outer surface of the insert 301 and the inner surface of tapered slot 204. The depositing may include, but not be limited to, powder spray, tape or foil deposition, physical vapor deposition (PVD), chemical vapor deposition (CVD), thermal spray, electrodeposition, hot dipping, cold dipping, laser based deposition, welding based deposition, and combinations thereof. Braze material may include, but not be limited to, gold, copper, silver, platinum, palladium, nickel, titanium, vanadium, zirconium, cobalt, and combinations thereof. The method includes sintering the layer of braze material on the outer surface of the insert 301 to fabricate diffusion layer 302 (step 105).

Sintering may be conducted at a temperature between about 1800 and about 2300° F. Thus, in various embodiments, the sintering may be conducted at a temperature from about 1800 to about 2300° F., from about 1850 to about 2250° F., from about 1900 to about 2200° F., from about 1950 to about 2150° F., or from about 2000 to about 2100° F., preferably from about 1900 to about 2175° F., including increments and intervals therein. The sintering may be conducted in inert gas environment. The sintering, for example, may be conducted in either a vacuum or hydrogen furnace. The sintering temperature may be sufficient to transform the layer of braze material into diffusion layer 302.

The method further includes positioning the insert 301 with the diffusion layer 302 into the tapered slot 204 (step 106). The insert 301 may be positioned into the tapered slot 204 with tight/press fit.

The method further includes brazing diffusion layer 302 to join insert 301 to the component 201 (step 107). The brazing may be conducted at a temperature sufficient to melt at least a portion of diffusion layer 302 but not the component 201. The melt portion of diffusion layer 302 may bond the insert 301 to the component 201 with a narrow braze gap size. Thus, in various embodiments, the brazing may be conducted at a temperature from about 1800 to about 2350° F., from about 1850 to about 2300 ° F., from about 1900 to about 2250° F., from about 1950 to about 2200 ° F., from about 2000 to about 2150° F., or from about 2050 to about 2100° F., including increments and intervals therein. In one embodiment, the brazing may be conducted at a temperature between about 1800 and about 2350° F., preferably from about 2050 to about 2225° F. The brazing may be conducted along with a thermal cycle.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for treating a component comprising the steps of:
machining a tapered slot in the component to remove a portion of the component;
measuring the tapered slot to determine the tapered slot dimensions;
forming an insert to have a corresponding geometry to the tapered slot with a braze gap between an outer surface of the insert and an inner surface of the tapered slot;
depositing a layer of a braze material on the outer surface of the insert;
sintering the layer of the braze material on the outer surface of the insert to fabricate a diffusion layer;
positioning the insert into the tapered slot; and
brazing the component to join the insert to the component.

2. The method of claim 1, wherein the measuring comprises utilizing a measurement system selected from the group consisting of white light 3D measurement system, a blue light 3D measurement system, a laser based measuring system, and combinations thereof.

3. The method of claim 1, wherein the forming the insert comprises machining.

4. The method of claim 1, wherein the forming the insert comprises a process selected from the group consisting of post-fabrication drilling, electrical discharge machining (EDM), laser drilling, mechanical drilling, vibrational drilling, milling, computer numerical control milling, water jet cutting, abrasive jet cutting, punching, formation by an additive manufacturing technique, 3D printing, and combinations thereof.

5. The method of claim 1, wherein the depositing comprises a process selected from the group consisting of powder spray, tape or foil deposition, physical vapor deposition (PVD), chemical vapor deposition (CVD), thermal spray, electrodeposition, hot dipping, cold dipping, laser based deposition, welding based deposition, and combinations thereof.

6. The method of claim 1, wherein a thickness of the layer is the same as the braze gap spaced between the outer surface of the insert and the inner surface of the tapered slot.

7. The method of claim 1, wherein the component comprises an alloy.

8. The method of claim 7, wherein the alloy comprises a superalloy material selected from the group consisting of nickel-based superalloy, cobalt-based superalloy, iron-based superalloy, titanium-based superalloy, and combinations thereof.

9. The method of claim 1, wherein the component comprises a material selected from the group consisting of a single crystal (SX) material, a directionally solidified (DS) material, an equiaxed crystal (EX) material, and combinations thereof.

10. The method of claim 1, wherein the insert comprises a material selected from the group consisting of a single crystal (SX) material, a directionally solidified (DS) material, an equiaxed crystal (EX) material, and combinations thereof.

11. The method of claim 1, wherein the insert includes a material that is the same as a material of the component.

12. The method of claim 1, wherein the insert includes a material that is dissimilar from a material of the component.

13. The method of claim 1, wherein the braze gap is sufficiently small to provide a tensile strength of greater than about 500 MPa at room temperature.

14. The method of claim 1, wherein the braze gap is between about 0.0005 and about 0.01 inches.

15. The method of claim 1, wherein the braze material comprises a material selected from the group consisting of gold, copper, silver, platinum, palladium, nickel, titanium, vanadium, zirconium, cobalt, and combinations thereof.

16. The method of claim 1, wherein the sintering is conducted at a temperature between about 1800 and about 2300° F.

17. The method of claim 1, wherein the brazing is conducted at a temperature between about 1800 and about 2350° F.

18. The method of claim 1, wherein the component is a turbine component selected from the group consisting of at least one of blades (buckets), vanes (nozzles), shrouds, combustor liners, and transition ducts.

19. A method for treating a superalloy turbine component comprising the steps of:
machining a tapered slot in the superalloy turbine component to remove a defect-containing portion of the superalloy turbine component;
measuring the tapered slot to determine the tapered slot dimensions;
forming an insert to have a corresponding geometry to the tapered slot with a braze gap ranging from about 0.0005 to about 0.01 inches between an outer surface of the insert and an inner surface of the tapered slot;
depositing a layer of a braze material on the outer surface of the insert;
sintering the layer of the braze material on the outer surface of the insert to fabricate a diffusion layer at a temperature between about 1800 and about 2300° F.;
positioning the insert into the tapered slot; and
brazing the superalloy turbine component to join the insert to the superalloy turbine component at a temperature between about 1800 and about 2350 ° F.

20. A treated superalloy turbine component comprising:
a surface having a tapered slot;
an insert positioned to the tapered slot with a braze gap ranging from 0.0005 to 0.01 inches between an outer surface of the insert and an inner surface of the tapered slot; and
a braze joint comprising a braze material positioned in the braze gap, the braze material having been sintered on the outer surface of the insert, the superalloy turbine component having a diffusion layer between the insert and the superalloy turbine component.
